(19) United States
(12) Patent Application Publication
(10) Pub. No.: US 2025/0298546 A1
(43) Pub. Date: Sep. 25, 2025

(54) INFORMATION PROCESSING SYSTEM, NON-TRANSITORY COMPUTER READABLE MEDIUM AND METHOD

(71) Applicant: FUJIFILM Business Innovation Corp., Tokyo (JP)

(72) Inventor: Nobumi KUSANO, Kanagawa (JP)

(73) Assignee: FUJIFILM Business Innovation Corp., Tokyo (JP)

(21) Appl. No.: 18/779,777

(22) Filed: Jul. 22, 2024

(30) Foreign Application Priority Data
Mar. 25, 2024 (JP) 2024-048711

(51) Int. Cl. G06F 3/12

(52) U.S. Cl. CPC G06F 3/1204; G06F 3/1236; G06F 3/1292

(57) ABSTRACT

An information processing system includes a processor configured to: generate a display screen for an information processing apparatus; and set a state where connection information for establishing connection with respect to image information for the generated display screen is allowed to be received by an external terminal device that has been brought in proximity at a distance at which reading is possible with respect to the information processing apparatus.

### CROSS-REFERENCE TO RELATED APPLICATIONS

This application is based on and claims priority under 35 USC 119 from Japanese Patent Application No. 2024-048711 filed Mar. 25, 2024.

### BACKGROUND

### (i) Technical Field

The present disclosure relates to an information processing system and a non-transitory computer readable medium.

### (ii) Related Art

Japanese Unexamined Patent Application Publication No. 2012-040880 discloses an image processing apparatus that generates a processing situation of a job in the image processing apparatus as a web page, allowing the web page to be viewed on a terminal device connected via a network.

Furthermore, Japanese Unexamined Patent Application Publication No. 2012-014280 discloses an information transmission apparatus that allows a screen common to a screen displayed on a display unit to be confirmed on an external device. Among the information apparatuses, a web page including image data indicating a screen common to a screen displayed on the display unit that the information transmission apparatus includes is generated, and the generated web page is transmitted to the information processing apparatus.

Japanese Unexamined Patent Application Publication No. 2015-230539 discloses an image forming apparatus that uses a short-range wireless communication technique to allow a desired application to be started when a mobile terminal is simply brought to touch the image forming apparatus, provide an instruction for executing printing and confirm a situation on the mobile terminal.

### SUMMARY

Conventionally, an image processing apparatus having a web server function is known. In such an image processing apparatus, a processing situation of a job in the image processing apparatus is generated as a web page, allowing the web page to be viewed on a terminal device connected via a network. However, it has been necessary for a user, for example, to visually inspect or search and retrieve, and confirm connection information such as a uniform resource locator (URL) indicating a location of a web page. For example, when a URL is displayed on a display unit of the image processing apparatus, it has been necessary for the user to manually input the URL that is visually recognized and confirmed to the terminal device. Alternatively, for example, it has been necessary for the user to access an image processing apparatus or a server from the terminal device via the network and search for and retrieve, for example, a URL of a web page corresponding to the image processing apparatus.

Therefore, aspects of non-limiting embodiments of the present disclosure relate to provision of an information processing system and a non-transitory computer-readable recording medium storing a program, which allow connection information for establishing connection with respect to image information for a display screen for an information processing apparatus to be acquired with a simpler operation, compared with a case where a user visually recognizes or searches and retrieves, and acquires such information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: generate a display screen for an information processing apparatus; and set a state where connection information for establishing connection with respect to image information for the generated display screen is allowed to be received by an external terminal device that has been brought in proximity at a distance at which reading is possible with respect to the information processing apparatus.

### BRIEF DESCRIPTION OF THE DRAWINGS

Exemplary embodiments of the present disclosure will be described in detail based on the following figures, wherein:

FIG. 1 is a diagram illustrating an example of a configuration of an image processing system according to a first exemplary embodiment;

FIG. 2 is a diagram illustrating a hardware configuration of an image processing apparatus according to the first exemplary embodiment;

FIG. 3 is a block diagram illustrating a functional configuration of the image processing apparatus according to the first exemplary embodiment;

FIG. 4 is a sequence diagram illustrating a flow of processing in the image processing system according to the first exemplary embodiment;

FIG. 5 is a sequence diagram subsequent to FIG. 4, according to the first exemplary embodiment;

FIG. 6 is a diagram illustrating an example of an initial screen displayed on a user interface (IF) device in the image processing apparatus according to the first exemplary embodiment;

FIG. 7 is a diagram illustrating an example of a service screen displayed on the user IF device in the image processing apparatus according to the first exemplary embodiment;

FIG. 8 is a diagram illustrating an example of a processing-under-execution screen displayed on the user IF device in the image processing apparatus according to the first exemplary embodiment;

FIG. 9 is a diagram illustrating an example of the processing-under-execution screen displayed on the user IF device in the image processing apparatus according to the first exemplary embodiment;

FIG. 10 is a diagram illustrating an example of a processing-under-execution screen displayed on a display device of a smartphone according to the first exemplary embodiment;

FIG. 11 is a block diagram illustrating a functional configuration of an image processing apparatus according to a second exemplary embodiment;

FIG. 12 is a diagram illustrating an example of a processing-under-execution screen displayed on a display device of a smartphone according to a third exemplary embodiment;

FIG. 13 is a diagram illustrating an example of a return operation reception screen displayed on the display device of the smartphone according to the third exemplary embodiment;

FIG. 14 is a flowchart illustrating an example of processing for returning an operation screen to an image processing apparatus in the third exemplary embodiment;

FIG. 15 is a diagram illustrating an example of a processing-under-execution screen returned to and displayed on a user IF device in the image processing apparatus according to the third exemplary embodiment; and

FIG. 16 is a diagram illustrating an example of an end-of-display screen to be displayed on the display device of the smartphone according to the third exemplary embodiment.

### DETAILED DESCRIPTION

### First Exemplary Embodiment

An image processing system 10 according to a first exemplary embodiment of the present disclosure will now be described herein in detail with reference to the accompanying drawings.

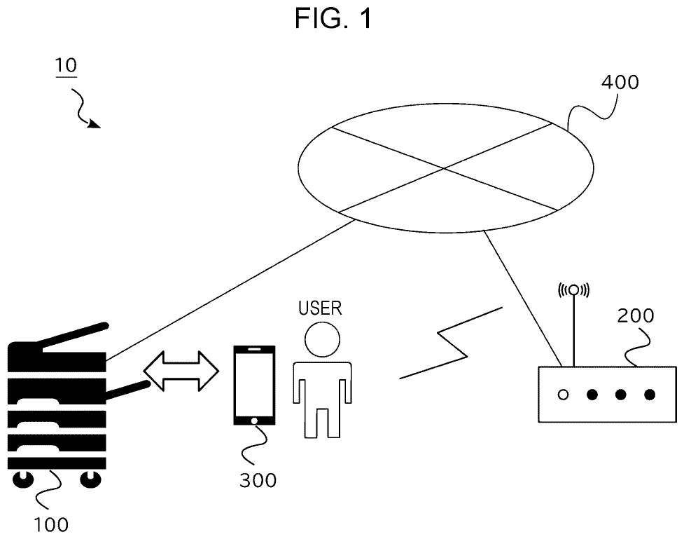

FIG. 1 is a diagram illustrating an example of a configuration of the image processing system 10 representing an exemplary embodiment of an information processing system according to the present disclosure. As illustrated in FIG. 1, the image processing system 10 according to the first exemplary embodiment includes an image processing apparatus 100, a wireless local area network (LAN) access point 200, and a smartphone 300 serving as an external terminal device. The image processing apparatus 100 and the wireless LAN access point 200 are connected to a network 400 such as a local area network. Furthermore, the wireless LAN access point 200 and the smartphone 300 are connected to each other in a network manner via a wireless LAN. Note that the external terminal device, which is described as the smartphone 300 in the present exemplary embodiment, may be a computer terminal device having a communication function, which a user is able to carry, such as a tablet type computer or a notebook type personal computer.

As will be described later, in the first exemplary embodiment, an image displayed on a user interface screen of the image processing apparatus 100 is handed over to the smartphone 300, and, even after the user leaves the image processing apparatus 100, a state of a job being executed in the image processing apparatus 100 is confirmed.

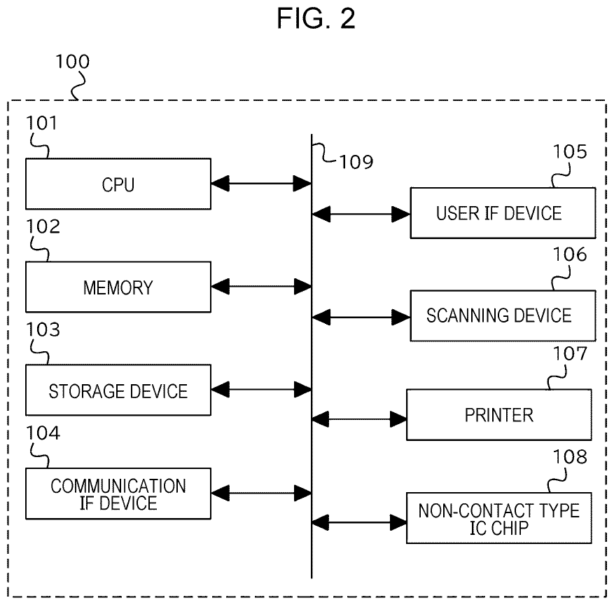

FIG. 2 is a diagram illustrating a hardware configuration of the image processing apparatus 100. As illustrated in FIG. 2, the image processing apparatus 100 includes a central processing unit (CPU) 101, a memory 102, and a storage device 103 such as a hard disk drive. In addition, the image processing apparatus 100 includes a communication IF device 104 for transmitting and receiving data via the network 400, a user IF device 105 including a touch panel and a liquid crystal display, a scanning device 106, a printer 107, and a non-contact type integrated circuit (IC) chip 108. Then, these components are connected to each other via a control bus 109.

The CPU 101 executes predetermined processing based on a control program stored in the memory 102 or the storage device 103 to control operation of the image processing apparatus 100. Note that it is also possible to store this control program in a portable storage medium such as a universal serial bus (USB) memory for provision to the CPU 101.

The control program for allowing the image processing apparatus 100 to operate is stored in the memory 102 and the storage device 103. Note that the control program may be stored in a portable medium such as a USB memory instead of the memory 102 and the storage device 103 for provision from the portable medium.

The communication IF device 104 allows communication with the smartphone 300 and the wireless LAN access point 200 connected to the network 400 through a non-illustrated LAN cable to be established. In addition, the communication IF device 104 is connected to a telephone line, and transmits and receives facsimile data to and from another image processing apparatus or a facsimile device, which is not illustrated.

The user IF device 105 is an input-and-output device including the liquid crystal display and the touch panel provided in the image processing apparatus 100, causes the liquid crystal display to display various types of screens, and receives an operation and an input provided by the user as the user performs operations on the touch panel.

The scanning device 106 reads a document placed on a non-illustrated document table, converts the read information into image data, and stores the image data in the memory 102 or the storage device 103. Furthermore, the printer 107 forms an image transmitted from a non-illustrated computer terminal connected to the image processing apparatus 100 via the network 400 on a recording medium such as a paper sheet. Furthermore, the image data temporarily stored in the memory 102 is printed on a paper sheet by the printer 107, transmitted to the computer terminal connected to the image processing apparatus 100 via the network 400, or transmitted to another image processing apparatus or a facsimile device through the telephone line.

The non-contact type IC chip 108 serves as a near field communication (NFC) tag, for example, and, when the smartphone 300 is brought in proximity to the non-contact type IC chip 108, wireless communication is established between the non-contact type IC chip 108 and the smartphone 300.

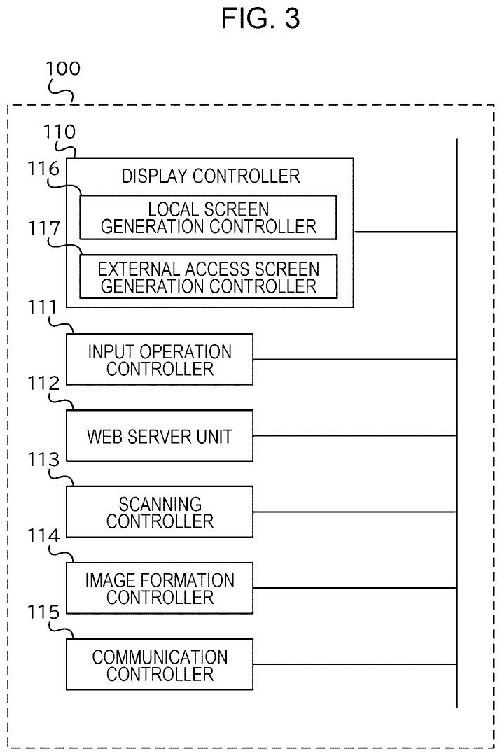

Next, a functional configuration of the image processing apparatus 100 will now be described herein with reference to FIG. 3. FIG. 3 is a block diagram illustrating the functional configuration of the image processing apparatus 100, which is achieved as the control program described above is executed in the CPU 101.

As illustrated in FIG. 3, the image processing apparatus 100 includes a display controller 110, an input operation controller 111, a web server unit 112, a scanning controller 113, an image formation controller 114, and a communication controller 115.

In addition, the display controller 110 includes a local screen generation controller 116 and an external access screen generation controller 117.

The local screen generation controller 116 generates an image of a display screen for displaying a situation of the image processing apparatus 100 on the liquid crystal display forming the user IF device 105. Note that examples of the display screen include an image of an operation screen for receiving an operation performed by the user, an image of a selection screen on which the user is allowed to perform an operation to perform image processing in the image processing apparatus 100, such as an initial screen and a processing-under-execution screen as will be described later, or an image of a screen for displaying a situation of image processing.

In accordance with a connection situation from the communication controller 115 to the smartphone 300, the local screen generation controller 116 prevents an image of an operation screen, which has been displayed on the liquid crystal display forming the user IF device 105, from being visually recognized from another device than the external terminal device. For example, the image of the operation screen is deleted or changed to an initial image.

The external access screen generation controller 117 generates an image of an operation screen to be displayed on a screen displayed on the smartphone 300, which corresponds to the operation screen displayed on the user IF device 105.

Note that a processor in the image processing apparatus 100 generates screen data that is necessary for displaying a display screen, specifically, a hypertext markup language (HTML) file, a portable network graphics (PNG) image that is necessary for displaying the HTML file, image layout information (in a form of a cascading style sheet (CSS)), control information (based on Javascript®), and the like.

The input operation controller 111 receives an input provided as the user performs an operation on the touch panel of the user IF device 105. For example, the user performs operations on the touch panel to provide input instructions for image processing, such as a copying operation, a scanning operation, and a facsimile transmission operation, and the input operation controller 111 receives these operations and provides instructions for corresponding operations to the scanning controller 113, the image formation controller 114, and the communication controller 115.

For example, as the user performs a copying operation by performing an operation on the touch panel, the input operation controller 111 outputs instructions to the scanning controller 113 and the image formation controller 114. Then, the scanning controller 113 scans a sheet placed on the document table and converts information on the sheet into image data, and the image formation controller 114 forms an image of the converted image data on a sheet.

Furthermore, as the user performs a scanning operation by performing an operation on the touch panel, the input operation controller 111 outputs an instruction only to the scanning controller 113. The scanning controller 113 scans a sheet placed on the document table, converts information on the sheet into image data, and stores the image data in the memory 102 or the storage device 103.

As the user performs an operation on the touch panel for facsimile transmission, the input operation controller 111 outputs instructions to the scanning controller 113 and the communication controller 115. The scanning controller 113 scans a sheet placed on the document table, converts information on the sheet into image data, and stores the image data in the memory 102 or the storage device 103. The stored image data is transmitted by the communication controller 115 to another image processing apparatus or a facsimile transmission-and-reception device, which is not illustrated, via the telephone line, for example.

The web server unit 112 issues a URL representing connection information for establishing connection from an external terminal device with respect to image information for an operation screen, which is generated by the external access screen generation controller 117. Note that this connection information may be issued for each image processing. Alternatively, each time an operation screen generated by the local screen generation controller 116 is switched, connection information for establishing connection with respect to image information for the operation screen, which is generated by the external access screen generation controller 117 accordingly, may be issued.

This connection information is associated with an operation screen for the smartphone 300, which corresponds to the operation screen displayed on the liquid crystal display of the user IF device 105. Then, after the operation screen has been switched, no information for the operation screen is transmitted even when the previously generated connection information has been accessed. Alternatively, after the operation screen has been switched, the previously generated connection information is prevented from being accessed.

The scanning controller 113 controls operation of the scanning device 106 in response to an instruction provided from the input operation controller 111, and stores image data read by the scanning device 106 in the memory 102 or the storage device 103.

The image formation controller 114 controls operation of the printer 107 in response to an instruction provided from the input operation controller 111 or an instruction provided from the non-illustrated computer terminal connected to the image processing apparatus 100 via the network 400, and performs image formation based on image data on a recording medium such as a paper sheet.

The communication controller 115 sets a state where connection information is allowed to be directly received by an external terminal device that has been brought in proximity at a distance at which reading is possible with respect to the image processing apparatus 100. That is, the communication controller 115 sets a state where direct reception is allowed by the smartphone 300 that is brought closer at a preset distance with respect to the non-contact type IC chip 108 installed on an outer surface or an inner surface of a housing of the image processing apparatus 100 or the liquid crystal display of the user IF device 105.

Specifically, the communication controller 115 sets a state where, as connection information issued by the web server unit 112 is written in the non-contact type IC chip 108, the connection information is allowed to be received by the external terminal device via proximity wireless communication. Note that, as the web server unit 112 has newly issued connection information, the communication controller 115 rewrites the connection information already written in the non-contact type IC chip 108 with the newly issued connection information.

Furthermore, the communication controller 115 detects or receives connection, which is identified based on the connection information, from the smartphone 300 with respect to an image of an operation screen, which is generated by the external access screen generation controller 117. In that case, the communication controller 115 controls operation of the communication IF device 104, and transmits the image of the operation screen to the smartphone 300 via the network 400.

Furthermore, the communication controller 115 controls operation of the communication IF device 104, and transmits the image data read by the scanning device 106 to another image processing apparatus or a facsimile device via the telephone line.

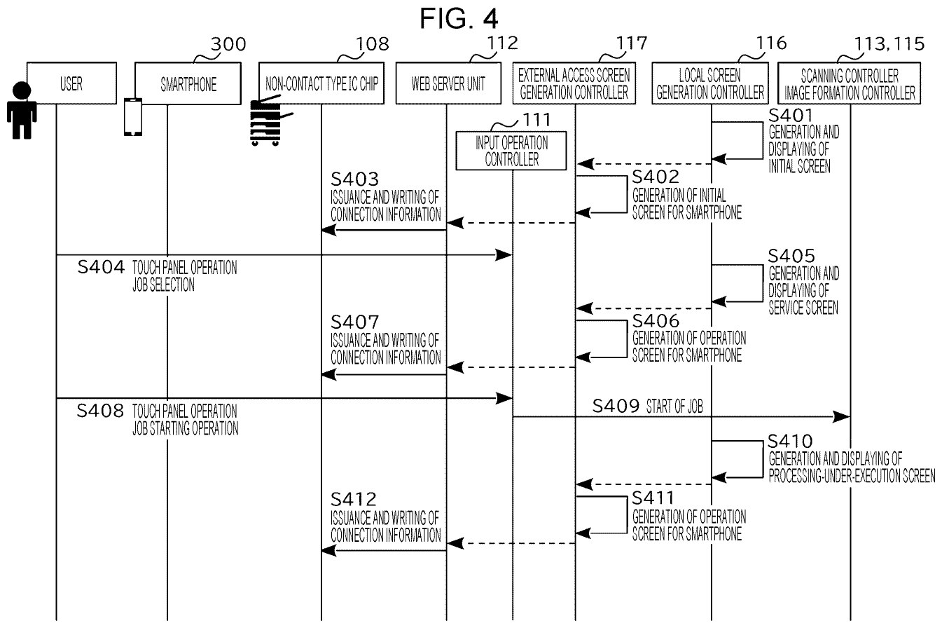

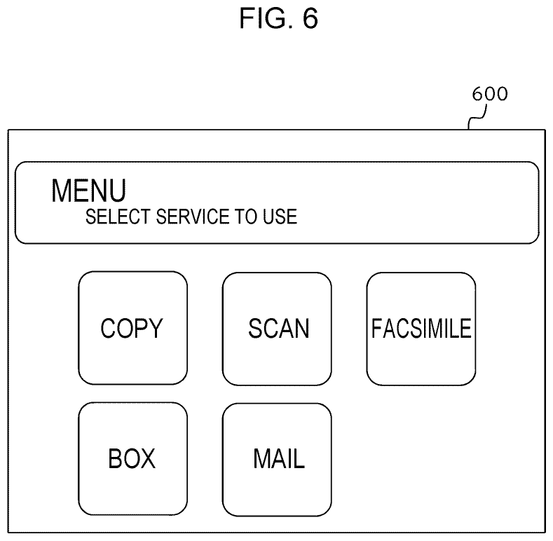

Operation of the image processing apparatus 100 configured as described above will now be described herein with reference to FIGS. 4 to 10. As illustrated in FIG. 4, in step S401, the local screen generation controller 116 generates and causes the liquid crystal display of the user IF device 105 to display an initial screen 600 as illustrated in FIG. 6. As illustrated in FIG. 6, the initial screen 600 represents an initial menu screen displaying options allowing processing such as “Copy”, “Scan”, “Facsimile”, “Box”, and “Mail” to be selected.

In step S402, the external access screen generation controller 117 generates an image of an operation screen for the smartphone 300, which corresponds to the initial screen 600.

In step S403, the web server unit 112 issues a URL representing connection information for establishing connection from the external terminal device with respect to image information for the operation screen generated by the external access screen generation controller 117. Then, the issued connection information is written in the non-contact type IC chip 108 installed on the outer surface or the inner surface of the housing of the image processing apparatus 100 to set a state where the connection information is allowed to be received by the external terminal device via proximity wireless communication. Note that the connection information to be written in the non-contact type IC chip 108 is written in an NFC data exchange format (NDEF) format, for example.

In step S404, the input operation controller 111 receives an operation that the user has performed on the touch panel of the user IF device 105. For example, it is assumed that the user has selected the “Facsimile” button on the initial screen 600 illustrated in FIG. 6. Then, the processing proceeds to step S405.

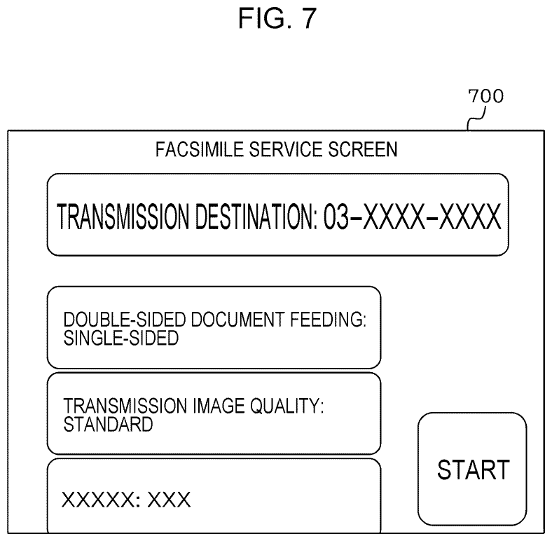

In step S405, the local screen generation controller 116 generates and causes the liquid crystal display of the user IF device 105 to display a facsimile service screen 700 as illustrated in FIG. 7. As illustrated in FIG. 7, the facsimile service screen 700 includes a transmission destination input field, a document feeding method designation field, a transmission image quality setting field, and the like. In addition, a “Start” button is displayed on the facsimile service screen 700.

In step S406, the external access screen generation controller 117 generates an image of an operation screen for the smartphone 300, which corresponds to the facsimile service screen 700.

In step S407, the web server unit 112 issues a URL representing connection information for achieving connection from the external terminal device with respect to image information for the operation screen generated by the external access screen generation controller 117. Then, the issued connection information is rewritten in place of the connection information already written in the non-contact type IC chip 108 to set a state where the new connection information is allowed to be received by the external terminal device via proximity wireless communication.

In step S408, the input operation controller 111 receives an operation that the user has performed on the touch panel of the user IF device 105. For example, it is assumed that the user has performed various types of settings and has selected the “Start” button on the facsimile service screen 700 illustrated in FIG. 7. Then, the processing proceeds to step S409.

In step S409, the input operation controller 111 outputs instructions to the scanning controller 113 and the communication controller 115, allowing image processing, which is also called a job, to be started. The image processing includes that the scanning controller 113 controls the scanning device 106, a sheet placed on the document table is scanned, and information on the sheet is converted into image data. Furthermore, the image processing includes that the communication controller 115 controls the communication IF apparatus 104 to perform transmission to another image processing apparatus or a facsimile transmission-and-reception device, which is not illustrated, via the telephone line, for example. Note that the scanned image data may be stored in the memory 102 and the storage device 103.

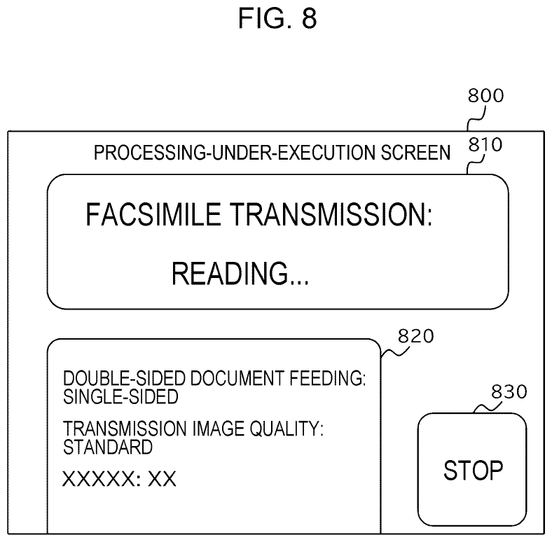

In step S410, the local screen generation controller 116 generates and causes the liquid crystal display of the user IF device 105 to display a processing-under-execution screen 800 as illustrated in FIG. 8. In the processing-under-execution screen 800 as illustrated in FIG. 8, the processing-under-execution screen 800 includes a processing situation display field 810, a setting content display field 820, and a “Stop” button 830. The processing situation display field 810 displays a message indicating a state of the image processing at a present point in time. The processing situation display field 810 illustrated in FIG. 8 displays, for example, a message “Facsimile transmission: Reading . . . ”.

In step S411, the external access screen generation controller 117 generates an image of an operation screen for the smartphone 300, which corresponds to the processing-under-execution screen 700.

In step S412, the web server unit 112 issues a URL representing connection information for establishing connection from the external terminal device with respect to image information for the operation screen generated by the external access screen generation controller 117. Then, the issued connection information is rewritten in place of the connection information already written in the non-contact type IC chip 108 to set a state where the new connection information is allowed to be received by the external terminal device via proximity wireless communication.

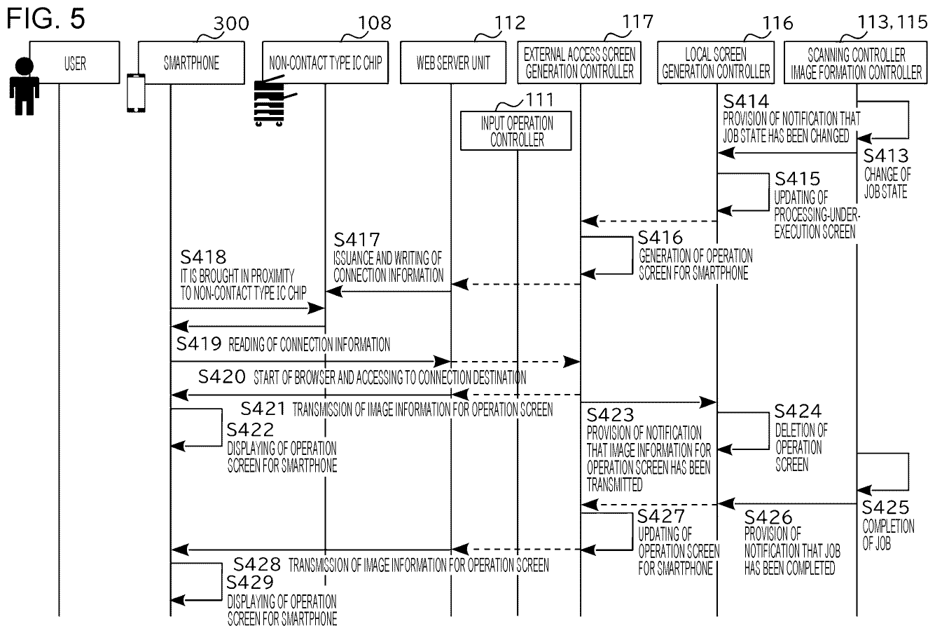

It is assumed in here that, in step S413 illustrated in FIG. 5, the state of the image processing has changed. Specifically, for example, it is assumed a case where, during scanning processing, reading of a document by the scanning device 106 has been completed, and transmission processing for image data by the communication IF device 104 has been started.

In this case, in step S414, the display controller 110 receives, from the scanning controller 113, a notification that reading processing for the document has been completed, and, from the communication controller 115, a notification that transmission of image data has been started.

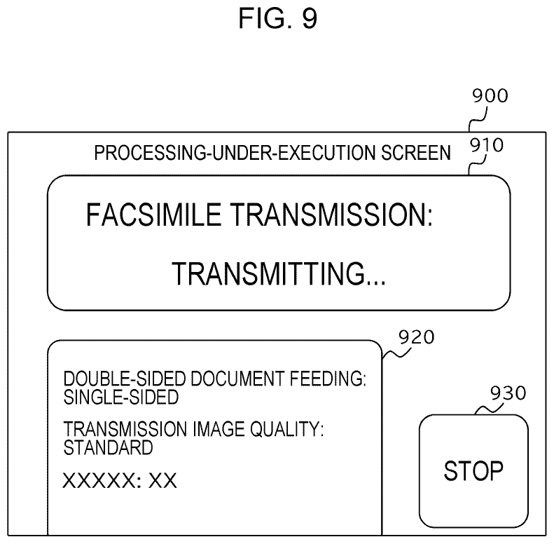

In step S415, as the display controller 110 has received the notifications, the local screen generation controller 116 updates display content of the processing-under-execution screen 700. For example, a processing-under-execution screen 900 as illustrated in FIG. 9 is generated and displayed on the liquid crystal display of the user IF device 105. The processing-under-execution screen 900 illustrated in FIG. 9 includes a processing situation display field 910, a setting content display field 920, and a “Stop” button 930. The processing situation display field 910 displays a message indicating a state of the image processing at a present point in time. The processing situation display field 910 illustrated in FIG. 9 displays, for example, a message “Facsimile transmission: Transmitting . . . ”.

In step S416, the external access screen generation controller 117 generates an image of an operation screen for the smartphone 300, which corresponds to the processing-under-execution screen 900.

In step S417, the web server unit 112 issues a URL representing connection information for establishing connection from the external terminal device with respect to image information for the operation screen generated by the external access screen generation controller 117. Then, the issued connection information is rewritten in place of the connection information already written in the non-contact type IC chip 108 to set a state where the new connection information is allowed to be received by the external terminal device via proximity wireless communication.

In step S418, it is assumed that the user has brought the smartphone 300 in proximity to the non-contact type IC chip 108. The term “proximity” includes in here an action of bringing the smartphone 300 close to or into contact with the non-contact type IC chip 108, for example, and refers to making a movement to a position at a distance at which it is possible to read connection information with respect to an operation screen displayed on the image processing apparatus 100.

Then, in step S419, the connection information written in the non-contact type IC chip 108 is read by the smartphone 300 that the user carries through proximity wireless communication.

As the connection information is read, the smartphone 300, in step S420, starts a browser and sets, based on the connection information, connection to the web server unit 112 in the image processing apparatus 100.

In response to the connection information received from the smartphone 300, the web server unit 112 acquires the image information for the operation screen generated by the external access screen generation controller 117 in step S417 described above.

In step S421, the web server unit 112 transmits the acquired image information for the operation screen to the smartphone 300.

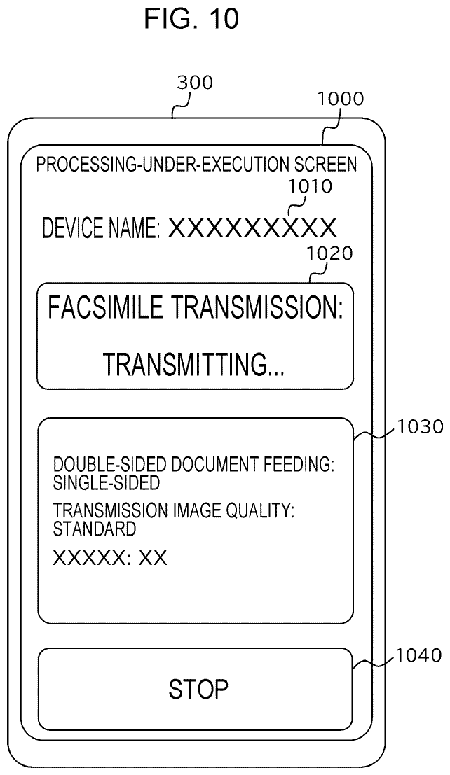

As the image information for the operation screen is received, the smartphone 300 causes the browser to display the image of the operation screen in step S422. FIG. 10 illustrates an example of a processing-under-execution screen 1000 displayed on the display device of the smartphone 300. Content of the processing-under-execution screen 1000, which is substantially similar or identical to the content of the processing-under-execution screen 900 described with reference to FIG. 9, is in a display aspect adapted to the display device of the smartphone 300, and is responsive, that is, has a layout allowing displaying to be achieved in accordance with a different screen size. Specifically, the processing-under-execution screen 1000 includes a device name display field 1010 for the image processing apparatus 100, a processing situation display field 1020, a setting content display field 1030, and a “Stop” button 1040. The processing situation display field 920 displays a message indicating a state of the image processing at a present point in time. The processing situation display field 1020 illustrated in FIG. 10 displays, for example, a message “Facsimile transmission: Transmitting . . . ”.

In step S423, the web server unit 112 notifies the local screen generation controller 116 that the image information for the operation screen has been transmitted to the smartphone 300.

In step S424, the local screen generation controller 116 deletes the image of the operation screen being displayed on the liquid crystal display of the user IF device 105. Furthermore, the local screen generation controller 116 changes the image of the operation screen being displayed on the liquid crystal display of the user IF device 105 to the initial image and displays the initial image. That is, the local screen generation controller 116 hides the processing-under-execution screen 1000, and generates and causes the liquid crystal display of the user IF device 105 to display the initial screen 600 as illustrated in FIG. 6. As a result, it is possible to allow another user to perform an operation on the touch panel while visually recognizing the liquid crystal display of the user IF device 105 to set other image processing. Note that, although, in this case, it is impossible to immediately start the other image processing by the other user because the image processing is already being executed at that point in time, it is possible to start the other image processing by the other user subsequently after the image processing currently being processed at the present point in time is completed.

In step S425, it is assumed that the state of the image processing has changed. Specifically, it is assumed a case where the transmission processing for the image data by the communication IF device 104 through the scanning processing has been completed.

In this case, in step S426, the communication controller 115 notifies the display controller 110 that the transmission processing for the image data has been completed.

In step S427, as the display controller 110 receives the notification described above, the external access screen generation controller 117 updates the image of the operation screen for the smartphone 300 since the processing-under-execution screen 900 has been hidden and has been switched to the other screen. For example, this screen is an image including a message that the facsimile transmission has been completed.

In step S428, the web server unit 112 transmits image information for the operation screen for the smartphone 300, which has been updated, to the smartphone 300.

In step S429, the smartphone 300 receives the image information for the operation screen and causes the browser to display the image of the operation screen.

It has been described above, in the first exemplary embodiment, the processing for handing over an image of an operation screen from the image processing apparatus 100 to the smartphone 300 by issuing and transmitting, to the smartphone 300, connection information for screen access utilizing proximity wireless communication. Note that proximity wireless communication has been utilized only for delivering connection information between the smartphone 300 and the image processing apparatus 100, and, after that, image data of an operation screen has been transmitted and received via the network 400 such as the Internet.

However, a method applied in the present disclosure is not limited to the method described above, and it may be set a state where connection information is allowed to be received by an external terminal device such as the smartphone 300 via short-range wireless communication such as Bluetooth (registered trademark) or WiFi (registered trademark) Direct, for example.

In that case, a code for executing an attempt of establishing connection based on Bluetooth with the smartphone 300 is embedded in the non-contact type IC chip 108, and the smartphone 300 is brought in proximity to the non-contact type IC chip 108. Then, connection based on Bluetooth is established between the smartphone 300 and the image processing apparatus 100. Next, connection information may be transmitted from the image processing apparatus 100 via Bluetooth to the smartphone 300 connected in advance in a wireless manner with the method described above. The smartphone 300 receives an image of an operation screen from the image processing apparatus 100 via Bluetooth based on the connection information. Note that similar connection and similar transmission-and-reception processing may be performed via WiFi Direct communication.

Furthermore, the non-contact type IC chip 108 may not be used, and short-range wireless communication connection such as Bluetooth connection or WiFi Direct connection may be established to transmit and receive connection information and an image of an operation screen. Specifically, candidate smartphones that are connectable via short-range wireless communication are displayed on the user IF device in the image processing apparatus 100, and connection with a selected one of the smartphones via short-range wireless communication is established. Next, connection information is transmitted to the smartphone connected via short-range wireless communication, and the smartphone is connected to an image of an operation screen based on the received connection information. Image data of a next operation screen is to be directly transmitted and received between the image processing apparatus 100 and the smartphone 300 via short-range wireless communication.

Note that, although connection information has been delivered to the smartphone 300 through wireless connection in the first exemplary embodiment described above, a method applied to the present disclosure is not limited to the method described above. For example, connection information may be displayed as code information on the liquid crystal display of the user IF device 105 in the image processing apparatus 100 to set a state where the smartphone 300 is able to perform imaging.

For example, the local screen generation controller 116 in the display controller 110 in the image processing apparatus 100 may convert connection information into a two-dimensional code and cause the liquid crystal display of the user IF device 105 to display the converted two-dimensional code to allow the smartphone 300 to capture the converted two-dimensional code.

Note that, in the first exemplary embodiment described above, an image of an operation screen is not displayed on the liquid crystal display of the user IF device 105 in the image processing apparatus 100 after the image of the operation screen is handed over to the smartphone 300, and therefore, it is impossible to visually recognize the image of the operation screen from another device than the smartphone 300. However, a method applied to the present disclosure is not limited to the method described above, and, even after an image of an operation screen is handed over to the smartphone 300, the image of the operation screen may be displayed on the liquid crystal display of the user IF device 105 in the image processing apparatus 100.

### Second Exemplary Embodiment

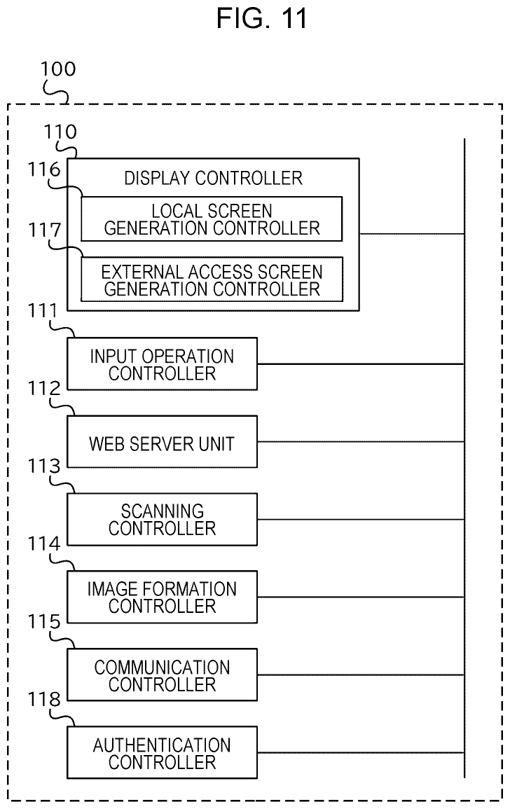

Next, an image processing system 10 according to a second exemplary embodiment will now be described herein. An image processing apparatus 100 according to the second exemplary embodiment is different from the image processing apparatus 100 according to the first exemplary embodiment in that an authentication controller 118 is included, as illustrated in a functional configuration block diagram illustrated in FIG. 11. However, since other parts in the configuration are substantially similar or identical to each other, the similar or identical components are therefore denoted by similar or identical reference signs, and detailed description of the components that have already been described is omitted.

The authentication controller 118 is able to receive an operation performed on the image processing apparatus 100 by the user authenticated in advance. That is, the authentication controller 118 instructs the local screen generation controller 116 to display an authentication screen when the user is about to perform an operation on the touch panel of the user IF device 105. As the user inputs authentication information to the authentication screen, the authentication controller 118 checks user information in the authentication information, and determines whether or not to permit the user to perform an operation on the user IF device 105.

It is assumed that, when the user is permitted to operate the user IF device 105, it is detected there is connection from the smartphone 300 with respect to image information for an operation screen, which is identified based on connection information, similar to the first exemplary embodiment described above. In this case, the web server unit 112 transmits the image information for the operation screen generated by the external access screen generation controller 117 to the smartphone 300. Furthermore, the authentication controller 118 sets an authentication state where it is possible to perform an operation on the operation screen from the smartphone 300, and sets an authentication cancellation state where it is impossible to perform an operation from the operation screen displayed on the liquid crystal display of the user IF device 105.

That is, when an operation screen is handed over to the smartphone 300 via proximity wireless communication, an authentication state of the image processing apparatus 100 is also handed over to the smartphone 300 in addition to the operation screen. Thus, it is possible to visually recognize, on the browser displayed on the smartphone 300, a state of processing being executed in the image processing apparatus 100, and, in addition, it is possible to perform an operation for the processing being executed. In addition, information such as a user name and a document name, which should be kept secret from another person than the authenticated user, is also displayed on the browser displayed on the smartphone 300.

In the second exemplary embodiment described above, it has been described an example where, with the smartphone 300 that the authenticated user carries, it is possible to hand over, from the image processing apparatus 100, and display an operation screen at any stage of processing being executed by the user of the image processing apparatus 100. However, a method applied to the present disclosure is not limited to the method described above. For example, the authentication controller 118 may set a connection permission level for image information for an operation screen during image processing. Then, in accordance with the permission level, the web server unit 112 issues connection information for the image information for the operation screen for which connection is permitted, and does not issue connection information for the image information for the operation screen for which connection is not permitted. As a result, information that is not desired to be displayed on an external terminal device other than the image processing apparatus 100 is prevented from being displayed on the smartphone 300.

### Third Exemplary Embodiment

Next, an image processing system 10 according to a third exemplary embodiment will now be described herein. In the image processing system 10 according to the third exemplary embodiment, displaying of an image of an operation screen on the liquid crystal display is restarted when a request for displaying again the image of the operation screen on the liquid crystal display of the user IF device 105 is received from the smartphone 300, in addition to the operation of the first exemplary embodiment.

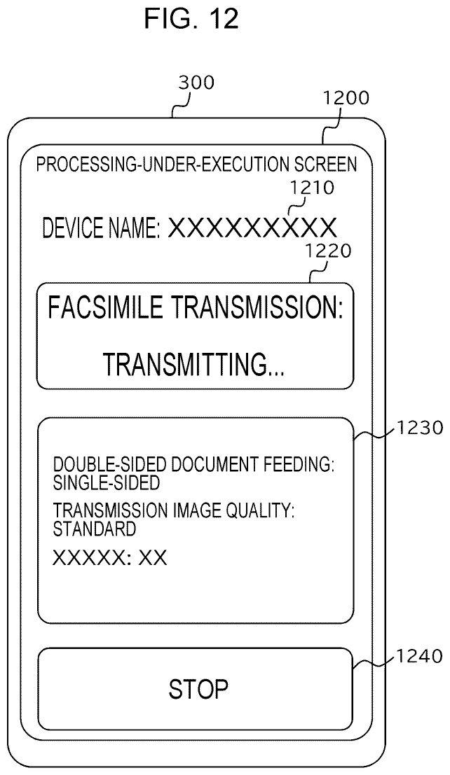

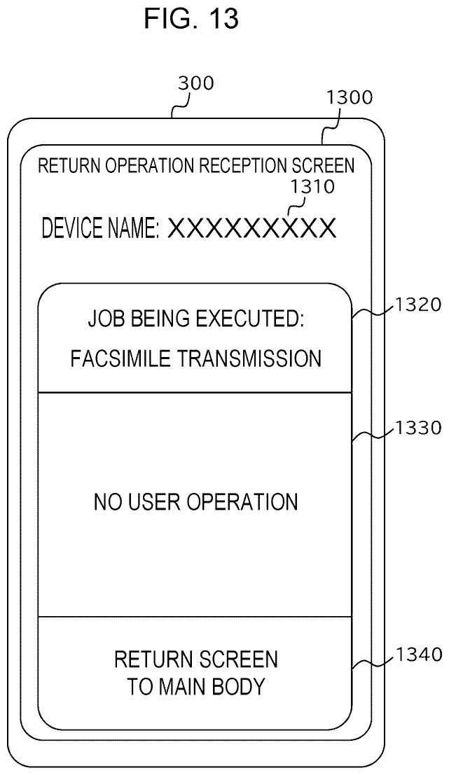

Specifically, although there is substantially similar or identical configuration to that illustrated in FIG. 10, according to the first exemplary embodiment, a processing-under-execution screen 1200 displayed on the smartphone 300 illustrated in FIG. 12 includes a device name display field 1210 for an image processing apparatus 100, a processing situation display field 1220, a setting content display field 1230, and a “Stop” button 1240. When the device name display field 1210 is selected in here, a return operation reception screen 1300 as illustrated in FIG. 13 is displayed on the browser displayed on the smartphone 300.

The return operation reception screen 1300 includes a device name display field 1310 for the image processing apparatus 100, a processing-under-execution display field 1320, an operation situation display field 1330, and a return button 1340. A message such as “Return screen to main body” is displayed on the return button 1340.

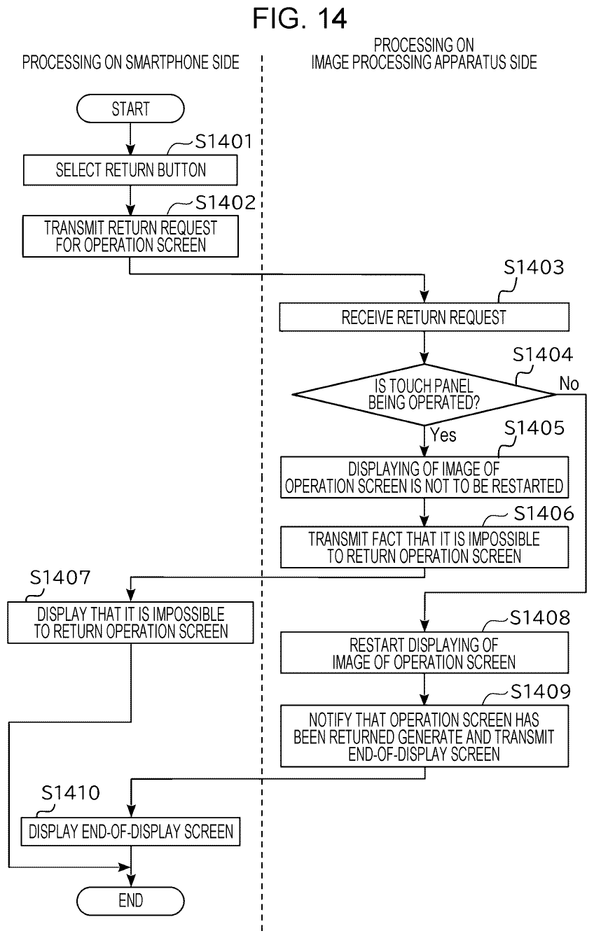

FIG. 14 is a flowchart illustrating processing for returning an operation screen to the image processing apparatus 100 in the third exemplary embodiment. In step S1401 illustrated in FIG. 14, as the user selects the return button 1240 displayed on the smartphone 300, the processing proceeds to step S1402.

In step S1402, the smartphone 300 transmits a request for returning the operation screen to the image processing apparatus 100. In step S1403, the image processing apparatus 100 receives the request for returning the operation screen. In step S1404, the input operation controller 111 in the image processing apparatus 100 determines whether or not the touch panel of the user IF device 105 is being operated. When it is determined that the touch panel is being operated, the processing proceeds to step S1405, and, when it is determined that the touch panel is not being operated, the processing proceeds to step S1408.

In step S1405, the local screen generation controller 116 does not restart displaying of an image of the operation screen on the liquid crystal display of the user IF device 105. Furthermore, in step S1406, the communication controller 115 notifies the smartphone 300 that the touch panel is being operated and it is impossible to return the operation screen to the image processing apparatus 100. In step S1407, the smartphone 300 receives this notification, displays that it is impossible to return the operation screen to the image processing apparatus 100, displays the processing-under-execution screen 1200 illustrated in FIG. 12, and ends the return processing.

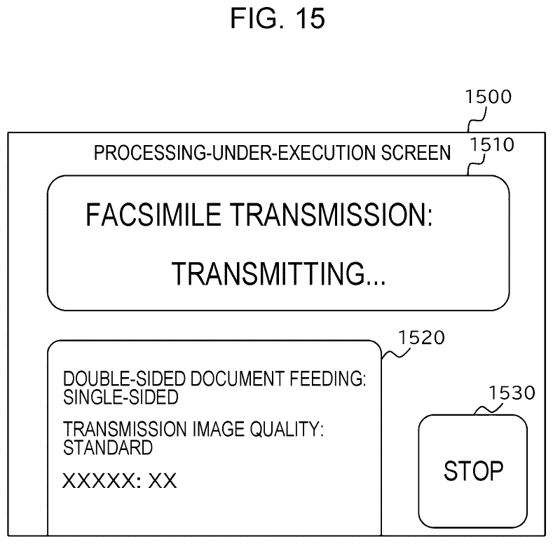

In step S1408, the local screen generation controller 116 causes the liquid crystal display of the user IF device 105 to display an image of an operation screen for displaying a processing situation of image processing, and the processing proceeds to step S1409. FIG. 15 is a diagram illustrating a processing-under-execution screen 1500 for which displaying is restarted on the liquid crystal display of the user IF device 105. The processing-under-execution screen 1500 includes a processing situation display field 1510, a setting content display field 1520, and a “Stop” button 1530. The processing situation display field 1510 displays a message indicating a state of the image processing at a present point in time. The processing situation display field 1510 illustrated in FIG. 15 displays, for example, a message “Facsimile transmission: Transmitting . . . ”.

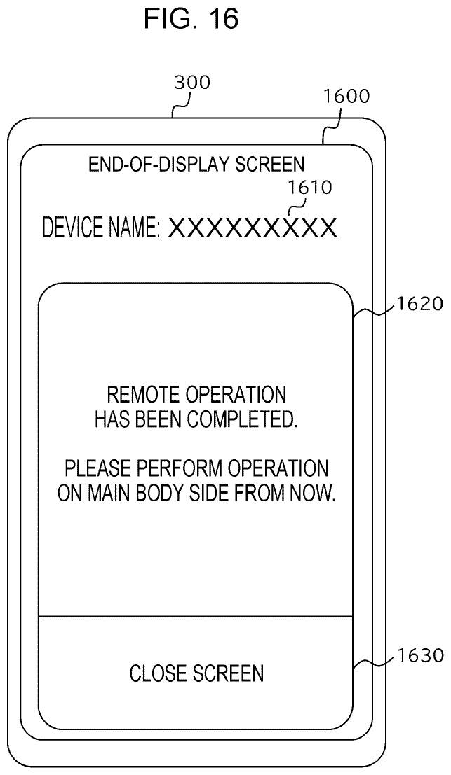

In step S1409, the communication controller 115 notifies the smartphone 300 that displaying of the operation screen on the image processing apparatus 100 has been restarted, and an instruction to end displaying of the operation screen on the smartphone 300. At this time, the external access screen generation controller 117 generates and transmits, to the smartphone 300, an end-of-display screen 1600 as illustrated in FIG. 16. In step S1410, the smartphone 300 displays the received end-of-display screen 1600.

The end-of-display screen 1600 includes a device name display field 1610 for the image processing apparatus 100, an end message display field 1620, and an end button 1630. The end message display field 1620 displays, for example, a message “Remote operation has been completed. Please perform operation on main body side from now.”. Furthermore, a message “Close screen” is displayed on the end button 1630, for example, and, as the user selects the end button 1630, a browser screen displayed on the smartphone 300 is closed, and the processing ends.

Note that, in the exemplary embodiments described above, the processor refers to a processor in a broad sense, and includes general-purpose processors (for example, central processing units (CPUs)) and dedicated processors (for example, graphics processing units (GPUs), application specific integrated circuits (ASICs), field programmable gate arrays (FPGAs), and programmable logic devices).

Furthermore, operations of the processor in the exemplary embodiments described above may be not only operations performed by one processor, but also operations performed, in cooperation with each other, by a plurality of processors that exist at physically distant positions. Furthermore, the order of the operations of the processor is not limited to only the order described in the exemplary embodiments described above, and may be modified as necessary.

### Appendix

(((1)))

An information processing system comprising a processor configured to: generate a display screen for an information processing apparatus; and set a state where connection information for establishing connection with respect to image information for the generated display screen is allowed to be received by an external terminal device that has been brought in proximity at a distance at which reading is possible with respect to the information processing apparatus.
(((2)))

The information processing system according to (((1))), wherein the processor is configured to set a state where the connection information is allowed to be received by the external terminal device via proximity wireless communication or via short-range wireless communication.
(((3)))

The information processing system according to (((2))), wherein the processor is configured to write the connection information in a non-contact type integrated circuit (IC) chip for proximity wireless communication to set a state where the connection information is allowed to be received by the external terminal device via proximity wireless communication.
(((4)))

The information processing system according to (((3))), wherein the processor is configured to issue the connection information for each image processing, and rewrites the connection information written in the non-contact type IC chip with the newly issued connection information.
(((5)))

The information processing system according to (((3))), wherein the processor is configured to transmit the connection information to an external terminal device connected in advance in a wireless manner via the short-range wireless communication.
(((6)))

The information processing system according to (((1))), further comprising a display device, wherein the processor is configured to cause the display device to display the connection information as code information to set a state where the external terminal device is able to perform imaging.
(((7)))

The information processing system according to (((1))), further comprising a display device, wherein, when it is detected that there is connection from the external terminal device with respect to the image information for the display screen, the connection being identified based on the connection information, the processor is configured to transmit the image information for the display screen displayed on the display device to the external terminal device; and prevent an image of the display screen from being visually recognized using a device other than the external terminal device.
(((8)))

The information processing system according to (((7))), wherein the processor is configured to delete the image of the display screen being displayed on the display device.
(((9)))

The information processing system according to (((7))), wherein the processor is configured to change the image of the display screen being displayed on the display device to an initial image and displays the initial image.
(((10)))

The information processing system according to any one of (((7))) to (((9))), wherein, when a request for causing the display device to display again the image of the display screen is received from the external terminal device, the processor is configured to cause the display device to restart displaying of the image of the display screen.
(((11)))

The information processing system according to (((10))), further comprising an input device, wherein, when a request for causing the display device to display again the image of the display screen is received from the external terminal device, and the input device is being operated, the processor is configured not to cause the display device to restart displaying of the image of the display screen and notifies the external terminal device that the input device is being operated.
(((12)))

The information processing system according to (((7))), wherein the processor is configured to not be able to receive an operation performed by a user authenticated in advance, and, when it is detected that there is connection from the external terminal device with respect to the image information for the display screen, the connection being identified based on the connection information, the processor is configured to set an authentication state where performing an operation on the display screen from the external terminal device is possible, and an authentication cancellation state where performing an operation on the display screen being displayed on the display device is impossible.
(((13)))

The information processing system according to (((7))), wherein the processor is configured to set a connection permission level for the image information for the display screen during image processing for performing displaying on the display device, and, in accordance with the connection permission level, issues the connection information with respect to the image information for the display screen for which connection is permitted; and not to issue the connection information with respect to the image information for the display screen for which connection is not permitted.
(((14)))

A program causing a computer to execute a process comprising: generating, when image processing is being performed, an image of a display screen for displaying a processing situation of the image processing; and setting a state where connection information for establishing connection from an external terminal device with respect to image information for the generated display screen is allowed to be directly received by the external terminal device that has been brought in proximity at a distance at which it is possible to read the connection information with respect to the display screen.
(((15)))

A method comprising: generating a display screen for an information processing apparatus; and setting a state where connection information for establishing connection with respect to image information for the generated display screen is allowed to be received by an external terminal device that has been brought in proximity at a distance at which it is possible to read the connection information with respect to the information processing apparatus.

What is claimed is:

1. An information processing system comprising:
a processor configured to:
generate a display screen for an information processing apparatus; and
set a state where connection information for establishing connection with respect to image information for the generated display screen is allowed to be received by an external terminal device that has been brought in proximity at a distance at which reading is possible with respect to the information processing apparatus.

2. The information processing system according to claim 1, wherein the processor is configured to set a state where the connection information is allowed to be received by the external terminal device via proximity wireless communication or via short-range wireless communication.

3. The information processing system according to claim 2, wherein the processor is configured to write the connection information in a non-contact type integrated circuit (IC) chip for proximity wireless communication to set a state where the connection information is allowed to be received by the external terminal device via proximity wireless communication.

4. The information processing system according to claim 3, wherein the processor is configured to issue the connection information for each image processing, and rewrites the connection information written in the non-contact type IC chip with the newly issued connection information.

5. The information processing system according to claim 3, wherein the processor is configured to transmit the connection information to an external terminal device connected in advance in a wireless manner via the short-range wireless communication.

6. The information processing system according to claim 1, further comprising a display device, wherein the processor is configured to cause the display device to display the connection information as code information to set a state where the external terminal device is able to perform imaging.

7. The information processing system according to claim 1, further comprising a display device, wherein, when it is detected that there is connection from the external terminal device with respect to the image information for the display screen, the connection being identified based on the connection information, the processor is configured to: transmit the image information for the display screen displayed on the display device to the external terminal device; and prevent an image of the display screen from being visually recognized using a device other than the external terminal device.

8. The information processing system according to claim 7, wherein the processor is configured to delete the image of the display screen being displayed on the display device.

9. The information processing system according to claim 7, wherein the processor is configured to change the image of the display screen being displayed on the display device to an initial image and displays the initial image.

10. The information processing system according to claim 7, wherein, when a request for causing the display device to display again the image of the display screen is received from the external terminal device, the processor is configured to cause the display device to restart displaying of the image of the display screen.

11. The information processing system according to claim 8, wherein, when a request for causing the display device to display again the image of the display screen is received from the external terminal device, the processor is configured to cause the display device to restart displaying of the image of the display screen.

12. The information processing system according to claim 9, wherein, when a request for causing the display device to display again the image of the display screen is received from the external terminal device, the processor is configured to cause the display device to restart displaying of the image of the display screen.

13. The information processing system according to claim 10, further comprising an input device, wherein, when a request for causing the display device to display again the image of the display screen is received from the external terminal device, and the input device is being operated, the processor is configured not to cause the display device to restart displaying of the image of the display screen and notifies the external terminal device that the input device is being operated.

14. The information processing system according to claim 7, wherein the processor is configured to be able to receive an operation performed by a user authenticated in advance, and, when it is detected that there is connection from the external terminal device with respect to the image information for the display screen, the connection being identified based on the connection information, the processor is configured to set an authentication state where performing an operation on the display screen from the external terminal device is possible, and an authentication cancellation state where performing an operation on the display screen being displayed on the display device is impossible.

15. The information processing system according to claim 7, wherein the processor is configured to set a connection permission level for the image information for the display screen during image processing for performing displaying on the display device, and, in accordance with the connection permission level, issues the connection information with respect to the image information for the display screen for which connection is permitted; and not to issue the connection information with respect to the image information for the display screen for which connection is not permitted.

16. A non-transitory computer readable medium storing a program causing a computer to execute a process comprising:
generating, when image processing is being performed, an image of a display screen for displaying a processing situation of the image processing; and
setting a state where connection information for establishing connection from an external terminal device with respect to image information for the generated display screen is allowed to be directly received by the external terminal device that has been brought in proximity at a distance at which it is possible to read the connection information with respect to the display screen.

17. A method comprising:
generating a display screen for an information processing apparatus; and
setting a state where connection information for establishing connection with respect to image information for the generated display screen is allowed to be received by an external terminal device that has been brought in proximity at a distance at which it is possible to read the connection information with respect to the information processing apparatus.
